(19) United States
(12) Patent Application Publication
(10) Pub. No.: US 2026/0085623 A1
(43) Pub. Date: Mar. 26, 2026

(54) HEAT ENGINE THAT CAPTURES AND USES WASTE HEAT FOR INCREASED THERMAL EFFICIENCY

(71) Applicant: Emilio Panarella, Ottawa (CA)

(72) Inventor: Emilio Panarella, Ottawa (CA)

(21) Appl. No.: 19/408,134

(22) Filed: Dec. 3, 2025

Related U.S. Application Data
(63) Continuation-in-part of application No. 18/531,686, filed on Dec. 7, 2023.
(60) Provisional application No. 63/476,807, filed on Dec. 22, 2022.

(51) Int. Cl. F01K 3/26; F01K 3/18

(52) U.S. Cl. CPC F01K 3/26; F01K 3/186

(57) ABSTRACT

The cyclic steam engine is a device that is intended to provide users with an increased efficiency heat engine. More specifically, the device is a heat engine that captures and uses waste heat to increase its thermal efficiency. To accomplish this, the device includes a steam engine and a boiler with an exhaust chamber, wherein waste heat and steam collected in the exhaust chamber form the engine are recycled into the boiler. In other words, the heat dissipated from the steam engine is recovered, re-circulated and re-used, thereby increasing the thermal efficiency of the cyclic steam engine. The device further includes unidirectional valves, and pressure gauges that ensure that waste heat is circulated under correct pressures and thermodynamic conditions. Thus, the device provides users with the right conditions and components with a cyclic steam engine that has increased efficiency than the maximum theoretical efficiency of a heat engine.

### FIELD OF THE INVENTION

The present disclosure generally relates to heat engines. More specifically, the present disclosure relates to a cyclic steam engine with increased thermal efficiency, that captures and uses waste heat.

### BACKGROUND OF THE INVENTION

Carnot efficiency is the maximum theoretical efficiency a heat engine can achieve. It represents the upper limit of how effectively heat can be converted into work, based on the temperatures of the heat source and the cold sink, according to the Second Law of Thermodynamics.

Increased efficiency of conversion of heat to work in conventional heat engines is obtained through recovery, re-circulation and re-use of waste heat. It is found that most of the waste heat can be recovered, recirculated and re-used if the proper thermodynamics conditions of the operating engine are satisfied. An analysis done through numerical simulation and an experiment done with a model engine both confirm that the increase in thermal efficiency is limited only by the unavoidable heat losses due to engine material's heat conduction. It is found that the efficiency of conversion of heat to work is not limited by Carnot efficiency, which applies to a cycle where the waste heat is rejected into the outside ambient, but increases to higher thermal efficiency than Carnot's, because of the recovery, re-circulation and re-use of the waste heat in a cyclic engine. However, a cyclic heat engine that captures and reuses waste heat, thereby increasing the efficiency of the steam engine is not found in the current market.

Thus, it is an objective of the present invention to provide users with a steam engine with conditions for higher efficiency.

### SUMMARY OF THE INVENTION

The present invention is intended to provide users with a cyclic steam engine with increased efficiency. To accomplish this, the present invention comprises a steam engine with a boiler and an exhaust chamber, wherein waste heat and steam collected in the exhaust chamber are recycled into the boiler. In other words, the heat dissipated from a heat engine or steam engine is recovered, re-circulated and re-used, thereby increasing the thermal efficiency of the cyclic steam engine, with the help of specifically connected conduits and valves. Thus, the present invention provides conditions for creating a steam engine with increased efficiency.

### BRIEF DESCRIPTION OF THE DRAWINGS

FIG. 1 illustrates a schematic diagram of a cyclic steam engine according to a preferred embodiment of the present invention.

FIG. 2 illustrates a top front perspective view of a model experimental engine, according to the present invention.

FIG. 3 illustrates a top elevational view of the model experimental engine, according to the present invention.

FIG. 4 illustrates a table of results created by a numerical simulation program (CyclePad) and their definition.

### DETAILED DESCRIPTION OF THE INVENTION

All illustrations of the drawings are for the purpose of describing selected versions of the present invention and are not intended to limit the scope of the present invention.

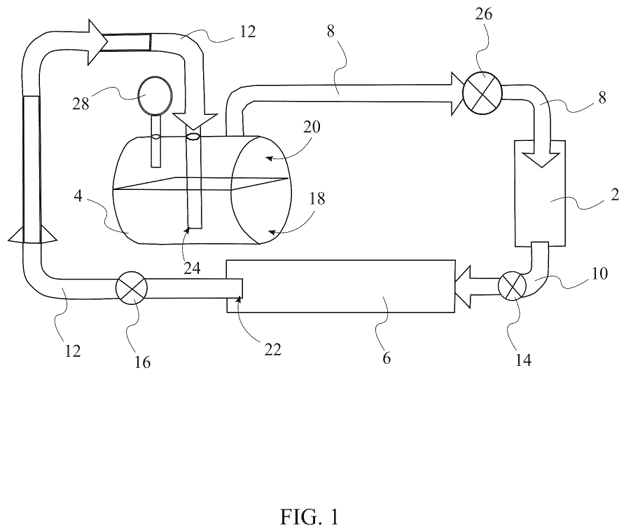

In reference to FIG. 1 through FIG. 4, the present invention is a cyclic steam engine.

According to a preferred embodiment, the present invention comprises a steam engine 2 and a boiler 4. Preferably, the steam engine 2 is a standard machine that converts thermal energy from steam into mechanical energy. In order to aid the working of the steam engine 2 by providing thermal energy in the form of steam, the boiler 4 is provided. The boiler 4 preferably is used to boil water and create high-pressure steam. This steam is then used to run a mechanical machine, such as to push a piston back and forth within a cylinder. To enable this, the boiler 4 is in fluid communication with the steam engine 2. This is how a general steam engine works. However, it is an aim of the present invention to recover, re-circulate and reuse waste heat that is typically dissipated into the outside atmosphere in a steam engine 2. To accomplish this, the present invention comprises an exhaust chamber 6, a steam inlet conduit 8, an exhaust conduit 10, a fluid recycling conduit 12, a first unidirectional valve 14, and a second unidirectional valve 16. As seen in FIG. 1, the exhaust chamber 6 is used to collect the waste heat from the steam engine 2. Preferably, the exhaust chamber 6 is a rectangular chamber and the boiler 4 is a cylindrical chamber made of a thermally resistant material. However, the exhaust chamber 6, the boiler 4, and the steam engine 2 may comprise any other shape, material, components, arrangement of components, etc. that are known to one of ordinary skill in the art, as long as the intents of the present invention are not altered. The steam inlet conduit 8 is used to pass steam from the boiler 4 into the steam engine 2. In other words, the steam inlet conduit 8 is connected between the boiler 4 and the steam engine 2. Similarly, the exhaust conduit 10 is connected between the steam engine 2 and the exhaust chamber 6. This is so that waste steam, hot air, water etc. from the steam engine 2 may pass to the exhaust chamber 6 through the exhaust conduit 10.

As seen in FIG. 1, the exhaust chamber 6 is connected between the steam engine 2 and the boiler 4. This is so that the waste steam/water collected in the exhaust chamber 6 may be easily recirculated back to the boiler 4. In other words, the exhaust chamber 6 is operatively coupled between the steam engine 2 and the boiler 4, wherein exhaust fluid collected in the exhaust chamber 6 is redirected to the boiler 4 for providing additional energy. To enable this, the fluid recycling conduit 12 is connected between the exhaust chamber 6 and the boiler 4. In other words, it is through the fluid recycling conduit 12 that the waste heat from the exhaust chamber 6 is sent to the boiler 4. Preferably, the fluid recycling conduit 12 is made of Vinyl tubing (PVC). The choice of such material is dictated by its low thermal conductivity (0.19 W/m K) relative to metal tubing, such as copper (401 W/m K), thus greatly reducing the heat loss into the surrounding ambient. Further, two different diameter vinyl tubing are used for the fluid recycling conduit 12. The central portion of the tubing has a length of approximately 50 cm and diameter 22.23 mm OD×15.88 mm ID, while the two peripheral parts have diameter 7.94 mm OD×4.76 mm ID, a length approximately 10 cm at the exhaust port, and approximately 20 cm at the boiler inlet port. This is because by providing a large volume for the exhaust steam, the engine can operate for a few cycles before having the fluid pressure increased to the pressure required for the operation at regime.

According to the preferred embodiment, the waste heat and fluid from the steam engine 2 goes into the exhaust chamber 6 through the first unidirectional valve 14 and is redirected into the boiler 4 through the second unidirectional valve 16. In other words, the first unidirectional valve 14 is operatively integrated within the exhaust conduit 10, wherein the first unidirectional valve 14 is used to allow exhaust fluids to pass from the steam engine 2 to the exhaust chamber 6 at a predetermined pressure level. Similarly, the second unidirectional valve 16 is operatively integrated within the fluid recycling conduit 12, wherein the second unidirectional valve 16 is used to allow exhaust fluids to pass from the exhaust chamber 6 to the boiler 4 at the predetermined pressure level. With this arrangement, only the same amount of fluid exiting from the exhaust chamber 6 can re-enter into the boiler 4, and the pressure, at any point of the fluid flow is constant during operation, thus allowing the engine to operate continuously. Further, the circulation of the fluid carrying the heat is only possible clockwise because of the action of the unidirectional valves and it is possible only if the fluid pressure is the same everywhere within the closed cycle. These are the thermodynamic conditions required for the engine to be able to recover, re-circulate and re-use the waste heat. Preferably, the first unidirectional valve 14 and the second unidirectional valve 16 are identical, are made of plastic, and are of the make, Model YXCC, that is ¼ in (6.5 mm) in diameter. However, any other components, materials, and dimensions that are known to one of ordinary skill in the art may be used for the conduits and valves, as long as the objectives of the present invention are not altered.

Thus, in order to enable smooth transfer of waste heat in the form of steam, hot air, and sometimes hot water, the exhaust conduit 10 is in fluid communication between the steam engine 2 and the exhaust chamber 6. Similarly, the fluid recycling conduit 12 is in fluid communication between the exhaust chamber 6 and the boiler 4.

As seen in FIG. 1, the boiler 4 holds both water and steam within its inner cavity as water boils and rises up as steam. More specifically, the boiler 4 comprises a water containing section 18 and a steam containing section 20, wherein the water containing section 18 is laterally offset from the steam containing section 20, and the steam containing section 20 is positioned adjacent to the water containing section 18. These distinct sections are created as water inside the boiler 4 is heated and steam is created on the upper sections of the boiler 4.

Continuing with the preferred embodiment, the fluid recycling conduit 12 comprises a first terminal end 22 a second terminal end 24. Preferably, the first terminal end 22 is positioned opposite to the second terminal end 24 along the fluid recycling conduit 12. In other words, the first terminal end 22 and the second terminal end 24 are opposing ends of the fluid recycling conduit 12. As seen in FIG. 1, the first terminal end 22 is positioned within the exhaust chamber 6, and the second terminal end 24 is positioned within the boiler 4. Further, the second terminal end 24 is immersed into the water containing section 18 of the boiler 4. This is because the exhaust steam that flows into the boiler 4 still contains residual heat in it. In order to capture as much as possible of such waste heat, it is advantageous to deposit it within the volume of the water where the temperature is the lowest, which is at the bottom of the water in the boiler 4.

Continuing with the preferred embodiment, the present invention comprises an on-off valve 26, wherein the on-off valve 26 is integrated along the steam inlet conduit 8. The on-off valve 26 helps users control the amount of steam that is sent from the boiler 4 into the steam engine 2. This is because the steam engine 2 is powered by the steam from the boiler 4.

In order to measure the working conditions and pressure build up at the heater or boiler 4, the present invention comprises a pressure gauge 28. As seen in FIG. 1 through FIG. 3, the pressure gauge 28 is operatively coupled to the boiler 4, wherein the pressure gauge is used to monitor the pressure variations within the boiler 4. However, it should be noted that the present invention may comprise any other monitoring equipment or valves mounted at any other location, as long as the intents of the present invention are not altered.

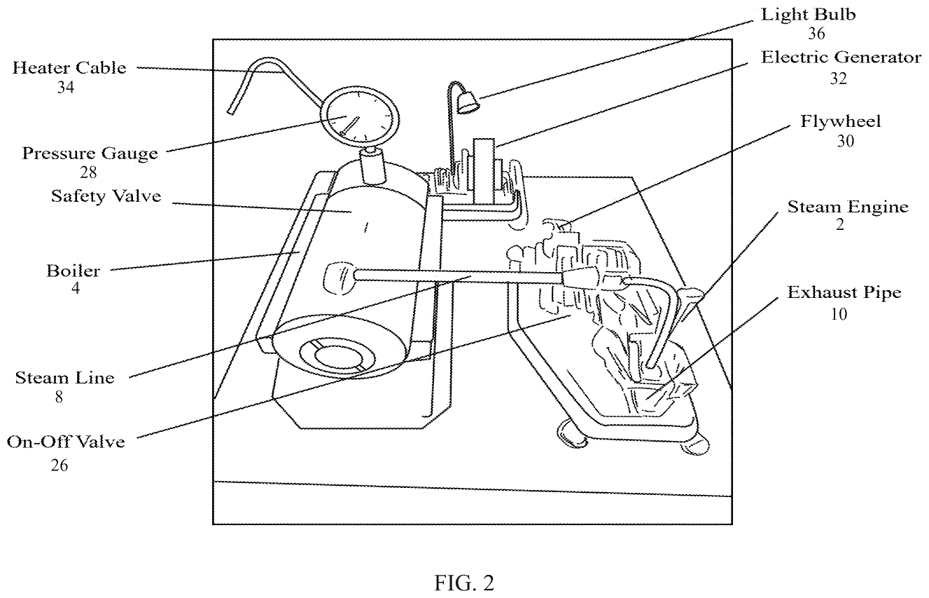

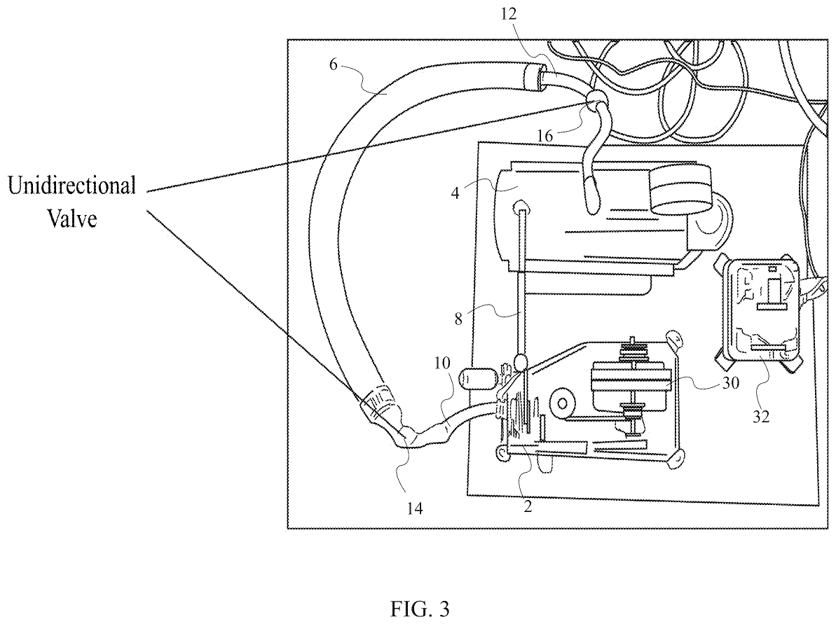

In reference to FIG. 2 and FIG. 3, the present invention comprises certain other components to establish a working model steam engine. Accordingly, the present invention comprises a mechanical segment 30, and an electric generator 32. Preferably, the mechanical element 30 is operatively coupled to the steam engine 2, wherein the mechanical segment 30 is powered by the pressure of the steam from the steam engine 2. In other words, the steam engine 2 provides the energy for the mechanical segment 30 to work, by converting thermal energy into kinetic energy. In the preferred embodiment, the mechanical segment 30 is a flywheel. However, any other mechanical segment 30 such as a piston and cylinder, a mechanical pedal, etc. may be used, as long as the objectives of the present invention are not altered. Further, the electric generator 32 is operatively coupled to the mechanical segment 30, wherein the electric generator 32 converts mechanical energy of the mechanical segment 30 into electrical energy. In reference to FIG. 2, the present invention comprises a light bulb 34, wherein the light bulb 34 is electrically connected to the electric generator 32. However, the electric generator 32 may be connected to any other circuit or device, as long as the intents of the present invention are fulfilled.

In order to provide heat or thermal energy to the boiler 4, the present invention comprises a heater cable 36. Preferably, the heater cable 36 is electrically connected to the boiler 4 so that heat is provided to the water inside the boiler 4. In other words, the heater cable 34 is thermally coupled to the boiler 4, wherein the heater cable 34 is used to heat water in the boiler 4. However, any other heat source may be used to provide thermal energy to the boiler, as long as the intents of the present invention are not altered.

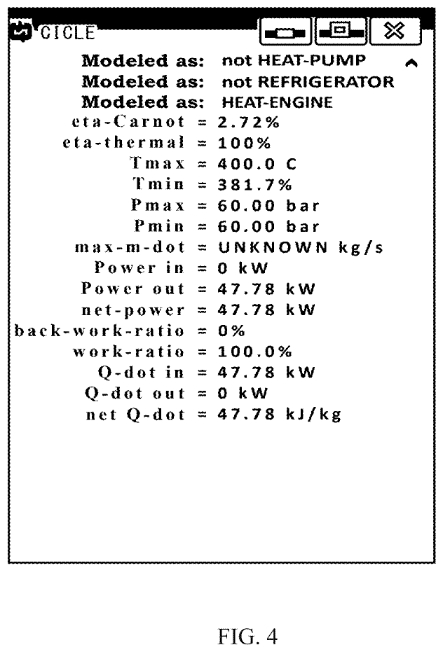

In reference to FIG. 4, a numerical simulation experiment is carried out to verify whether recovery, re-circulation and re-use of the heat is possible under the condition of constant pressure within the cycle, and whether the model engine is able to deliver some Net Work out of the cycle. The answer is positive on both counts and is confirmed from the analysis of the numerical results shown in FIG. 4. As seen in FIG. 4, the cycle operates at constant pressure 60 bar between temperatures Tmax=400 C=673.15 K and Tmin=381.7 C=654.85 K. The Cycle results report that the Carnot efficiency is 2.72%, as expected from the values of the mentioned Tmax and Tmin. This disclosed constant pressure engine is able to deliver Net Power=47.78 kW corresponding to an Input Heat Power of 47.78 kW, with a Thermal efficiency of 100%.

Further, a working model engine as shown in FIG. 2 and FIG. 3 was built and successfully operated, ensuring that recirculating and reusing waste heat in a cyclic heat engine under proper thermodynamic conditions can produce increased thermal efficiency than the maximum theoretical efficiency of a heat engine.

Although the invention has been explained in relation to its preferred embodiment, it is to be understood that many other possible modifications and variations can be made without departing from the spirit and scope of the invention as hereinafter claimed.

What is claimed is:

1. A cyclic heat engine with increased thermal efficiency comprising:
a steam engine;
a boiler;
an exhaust chamber;
an steam inlet conduit;
an exhaust conduit;
a fluid recycling conduit;
a first unidirectional valve;
a second unidirectional valve;
the boiler being in fluid communication with the stream engine;
the steam inlet conduit being connected between the boiler and the steam engine;
the exhaust chamber being connected between the steam engine and the boiler;
the exhaust conduit being connected between the steam engine and the exhaust chamber;
the fluid recycling conduit being connected between the exhaust chamber and the boiler;
the first unidirectional valve being operatively integrated within the exhaust conduit, wherein the first unidirectional valve is used to allow exhaust fluids to pass from the steam engine to the exhaust chamber at a predetermined pressure level;
the second unidirectional valve being operatively integrated within the fluid recycling conduit, wherein the second unidirectional valve is used to allow exhaust fluids to pass from the exhaust chambre to the boiler at the predetermined pressure level; and
the exhaust chamber being operatively coupled between the steam engine and the boiler, wherein exhaust fluid collected in the exhaust chamber is redirected to the boiler for providing additional energy.

2. The cyclic heat engine with increased thermal efficiency of claim 1, wherein the exhaust conduit is in fluid communication between the steam engine and the exhaust chamber.

3. The cyclic heat engine with increased thermal efficiency of claim 1, wherein the fluid recycling conduit is in fluid communication between the exhaust chamber and the boiler.

4. The cyclic heat engine with increased thermal efficiency of claim 1 further comprising:
the boiler comprising a water containing section and a steam containing section;
the steam containing section being laterally offset from the water containing section; and
the steam containing section being positioned adjacent to the water containing section.

5. The cyclic heat engine with increased thermal efficiency of claim 4 comprising:
the fluid recycling conduit comprising a first terminal end a second terminal end;
the first terminal end being positioned opposite to the second terminal end along the fluid recycling conduit;
the first terminal end being positioned within the exhaust chamber;
the second terminal end being positioned within the boiler; and
the second terminal being immersed into the water containing section of the boiler.

6. The cyclic heat engine with increased thermal efficiency of claim 1 comprising:
a on-off valve; and
the on-off valve being integrated along the steam inlet conduit.

7. The cyclic heat engine with increased thermal efficiency of claim 1 comprising:
a pressure gauge; and
the pressure gauge being operatively coupled to the boiler, wherein the pressure gauge is used to monitor the pressure variations within the boiler.

8. The cyclic heat engine with increased thermal efficiency of claim 1, wherein the steam engine being powered by the steam from the boiler.

9. The cyclic heat engine of claim 1 comprising:
a mechanical segment;
an electric generator;
the mechanical element being operatively coupled to the steam engine, wherein the mechanical segment is powered by the pressure of the steam from the steam engine; and
the electric generator being operatively coupled to the mechanical segment, wherein the electric generator converts mechanical energy of the mechanical segment into electrical energy.

10. The cyclic heat engine of claim 9, wherein the mechanical segment is a flywheel.

11. The cyclic heat engine of claim 9 comprising:
a light bulb; and
the light bulb being electrically connected to the electric generator.

12. The cyclic heat engine of claim 1 comprising:
a heater cable;
the heater cable being electrically connected to the boiler; and
the heater cable being thermally coupled to the boiler, wherein the heater cable is used to heat water in the boiler.
